(19) United States
(12) Patent Application Publication
(10) Pub. No.: US 2018/0022365 A1
(43) Pub. Date: Jan. 25, 2018

(54) Wall Arrangement For A Vehicle

(71) Applicant: SIEMENS AKTIENGESELLSCHAFT, MUENCHEN (DE)

(72) Inventors: STEPHAN BISSELS, STRAELEN (DE); STEFAN WANCZURA, RECKLINGHAUSEN (DE)

(21) Appl. No.: 15/547,627

(22) PCT Filed: Jan. 6, 2016
(86) PCT No.: PCT/EP2016/050109

§ 371 Date: Jul. 31, 2017

(30) Foreign Application Priority Data
Jan. 30, 2015 (DE) 10 2015 201 660.9

(51) Int. Cl. B61D 17/04; B61D 17/08; B61D 17/12

(52) U.S. Cl. CPC B61D 17/041; B61D 17/12; B61D 17/08; B60R 13/0206

(57) ABSTRACT

A wall configuration for a vehicle includes a sandwich panel having a core layer provided on either side with a respective metallic cover layer. Edge portions of the cover layers on at least one side of the sandwich panel project from an end face of the core layer. A metal connecting profile has an edge portion inserted into an interspace between the two projecting edge portions of the cover layers. Inner sides of the projecting edge portions of the cover layers are each structurally connected to an associated outer surface of the inserted edge portion of the connecting profile by a respective structural adhesive or bonding layer. At least one of the projecting edge portions of the cover layers is electrically conductively connected to the abutting the edge portion of the connecting profile by a weld seam at a distance from the adhesive-bonding layer.

The invention relates to a vehicle, in particular a rail vehicle, according to the preamble of claim 1.

Accordingly, a wall arrangement for a vehicle is disclosed, having a sandwich panel which comprises a core layer which is provided on both sides in each case with a metal cover layer, wherein edge portions of the cover layers protrude from an end face of the core layer on at least one side of the sandwich panel, and having a metal connecting profile which comprises an edge portion which is inserted into a space between the two protruding edge portions of the cover layers, wherein inside surfaces of the protruding edge portions of the cover layers are connected structurally to assigned outside surfaces of the inserted edge portion of the connecting profile in each case by means of an adhesive layer.

Such a wall arrangement is shown, for example, in DE 10 2012 2013 469 A1 of the Applicant. The roof wall arrangement put forward here provides a structural type bonding between the sandwich panel and a connecting profile.

The above-mentioned sandwich panels, which can be present, for example, as aluminum cover panels with bonded-in foam cores, are inherently rigid, light structural elements which are particularly suited for producing a flat, level or curved roof structure of a rail vehicle body. In order to enable simple integration into the body structure as a result of welding, the sandwich panel with its cover layers is bonded into a connecting profile produced from aluminum profiles. The bonding carried out does not have electrical conductivity sufficient for grounding purposes. Consequently, particular measures have to be taken in order to realize reliable grounding.

For such purposes, the prior art discloses connecting together two components, between which good electrical conductivity has to be provided, by means of grounding cables. To this end, however, a ground lug has to be welded on each component and the grounding cable fastened in turn on said ground lug in an electrically conducting manner.

Proceeding from here, the object underlying the invention is to develop further a wall arrangement of the type mentioned in the introduction in such a manner that, with a small amount of expenditure and effort, a reliable electrically conducting connection is created between the sandwich panel and the connecting profile.

Said object is achieved by a wall arrangement as claimed in claim 1.

Proceeding from the wall arrangement described in the introduction, it is accordingly provided that at least one of the protruding edge portions of the cover layers is connected so as to be electrically conducting to the edge portion of the connecting profile, said edge portion abutting against the inside surface of said protruding edge portion of the cover layers, at a spacing from the adhesive layer by means of a weld seam.

On account of the weld seam being present, there is an electrically conducting connection between the sandwich panel, in particular its protruding edge portion, and the connecting profile, said two components being able to be produced, for example, from aluminum. Consequently, the welding of ground lugs on the relevant components and the providing of the grounding line disclosed previously are no longer necessary.

In this case, the adhesive layer can be arranged facing the sandwich panel and the weld seam can be arranged facing the connecting profile. In this case, the adhesive layer has the function of creating a structural connection between the protruding edge portion of the cover layer and the connecting profile, whilst the main object of the weld seam is to produce an electrically conducting connection. The dimensions of the weld seam are correspondingly determined as a result of anticipated leakage currents being able to be conducted in a suitable manner without resulting in inadmissible rises in temperature or even in glowing or fusing of the weld seam.

A sealing layer can be arranged between the adhesive layer and the weld seam on the at least one protruding edge portion. Said sealing layer prevents adhesive running in the direction of the region in which the weld seam is to be arranged when joining the protruding edge portion to the connecting profile.

As an alternative to this, it is possible to arrange a groove for receiving excessive adhesive between the adhesive layer and the weld seam on the at least one protruding edge portion. Excessive adhesive is collected in said groove. Such a device is also designated as a “resin trap”.

Both measures explained as examples ensure that the weld region, which is at a spacing from the adhesive layer, is kept free of adhesive in a necessary manner.

The adhesive layer can have a width of between 20 and 50 mm on the at least one protruding edge portion. This ensures a suitable structural connection between the edge portion of the cover layer of the sandwich panel and the connecting profile. Depending on the mechanical load of the joining region, deviations from said width up or down can also be made.

The weld seam can be situated at a spacing, of for example at least 5 mm, from the adhesive layer on the at least one protruding edge portion. Maintaining said spacing ensures that the weld operation to realize the weld seam only influences the structure of the adhesive bond between the edge portion of the cover layer and the connecting profile in an insignificant manner.

The weld seam provided on the at least one protruding edge portion can be realized as a step seam (straight, corrugated). Electrically conducting contacts between the protruding edge portion of the cover layer and the connecting profile are created in the chosen step width in this way.

An adhesive layer free end region, which comprises a width of at least 10 mm and is provided for the weld seam, can be provided on the at least one protruding edge portion. The weld seam can be suitably arranged inside said width region, for example approximately in the middle.

In a preferred manner, the sandwich panel can form a roof wall; the connecting profile in the case of a rail vehicle would then be arranged, for instance, in the arched region.

The weld seam can preferably be produced by means of laser welding. Said welding process generates particularly small amounts of heat input in material regions adjacent to the weld seam.

In a cost-effective manner, a joining region between the sandwich panel and the connecting profile is realized in a mirror-symmetrical manner with reference to a middle longitudinal plane of the sandwich panel in the region of the two protruding edge portions of the cover layers. In this way, the two protruding edge portions of the cover layers of the sandwich panel are joined to assigned outside surfaces of the connecting profile in the same way and are provided with a weld seam to produce the electrical connection.

Exemplary embodiments of the invention are explained in more detail below with reference to the drawings, components with identical functions being designated with the same reference symbols, in which drawings:

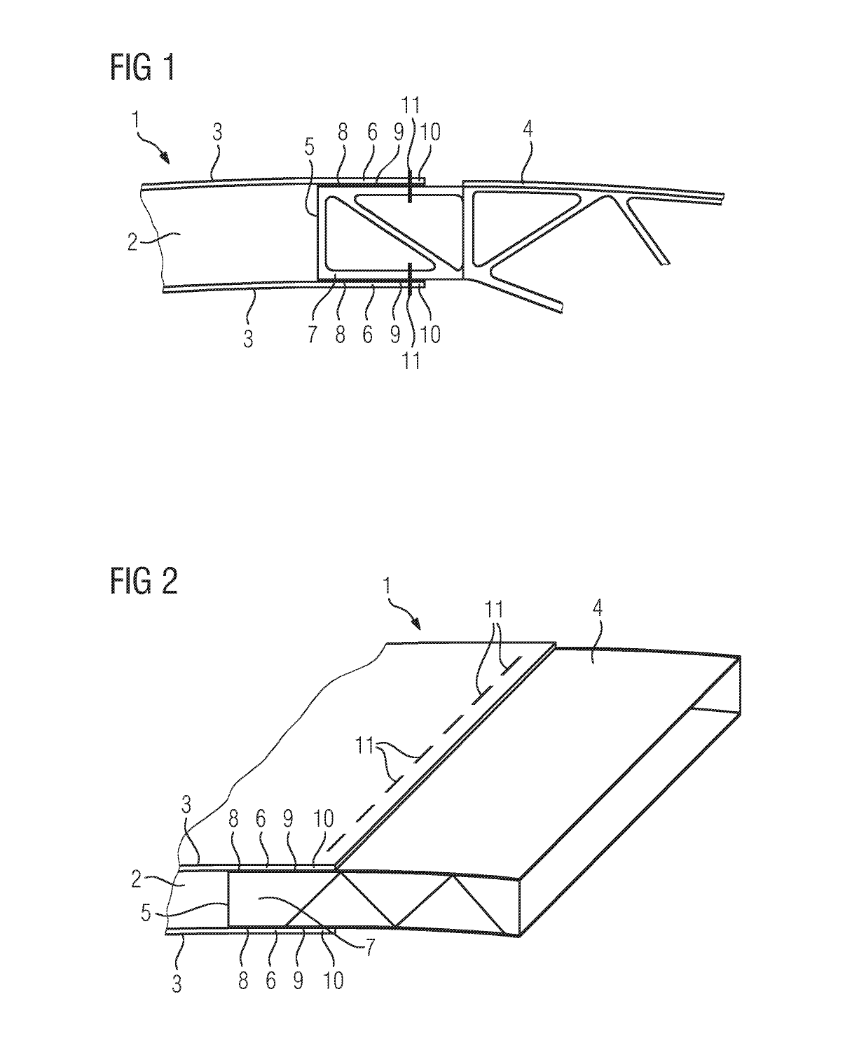

FIG. 1 shows a cross sectional view of a transition region between a sandwich panel and a connecting profile in the case of a railcar body of a rail vehicle,

FIG. 2 shows a perspective view of another transition region between a sandwich panel and a connecting profile and

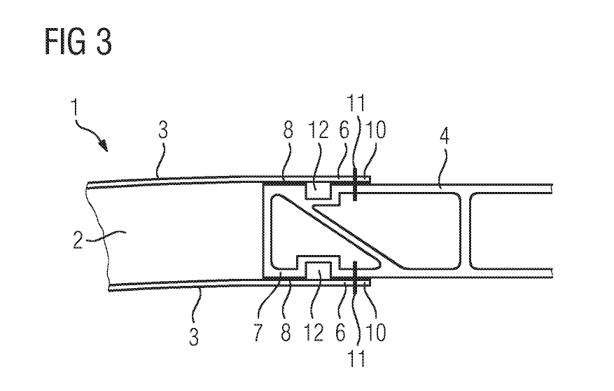

FIG. 3 shows a cross sectional view of a further transition region between a sandwich panel and a connecting profile.

As shown in FIG. 1, a body of a rail vehicle includes a sandwich panel 1 which realizes a roof wall in the present exemplary embodiment. The sandwich panel 1 comprises a foam core layer 2, the upper and lower sides of which are covered in each case with a metal cover layer 3. The cover layers 3 are bonded with the foam core layer 2.

To connect the sandwich panel 1 to the aluminum connecting profile 4, the sandwich panel 1 shows edge portions 6 of the cover layers 3 which protrude from an end face 5 of the foam core layer 2. The protruding edge portions 6 of the cover layers 3 form between them a space into which an edge portion 7, which is realized in a rectangular manner in cross section in the present exemplary embodiment, is inserted/fitted in such a manner that it butts against the end face 6 of the foam core layer 2 by way of its end face, whilst assigned outside surfaces of the end portion 7 of the connecting profile 4 abut against the inside surfaces of the edge portions 6 with structural adhesive layers 8 in between.

The structural adhesive layers 8 bring about the actual connection between the sandwich panel 1 and the connecting profile 4.

In the exemplary embodiment shown, a respective adhesive layer 8 starts at the end face 6 of the foam core layer 2 and extends in the direction of the connecting profile 4 over a width of, for example, 35 mm. Where required, the adhesive layers 8 can also be less wide or wider, for example they can be within the range of between 20 and 50 mm, in particular they can also have different widths.

In the exemplary embodiment according to FIG. 1, sealing strips 9, which prevent a flow of adhesive in the direction of the connecting profile 4 when joining the sandwich panel 1 to the connecting profile 5, connect to the adhesive layers 8 in the direction of the connecting profile 5.

The cover layers 3 show end regions 10 from the sealing strips 9. Said end regions 10 of the cover layers 3 overlap without an adhesive connection to assigned outside surfaces of the edge portion 7 of the connecting profile 4.

Weld seams 11 (shown schematically), which are realized as keyhole weld seams and create in each case an electrically conducting connection between the metal cover layers 3 of the sandwich panel 1 and the metal connecting profile 4, are provided approximately in the middle of the end regions 10. The weld seams 11 are situated in a typical manner at a spacing of at least 5 mm from the adhesive layer 8 which is present on the same side of the sandwich panel 1.

The weld seams 11 are dimensioned in such a manner that they are able to handle leakage currents that occur. A weld width of up to 6 mm, where applicable also up to 4 mm, is sufficient in a typical manner for this purpose.

The weld seams 11 are produced in a suitable manner by laser welding. They can be realized, as shown in FIG. 2, as step seams, for example with individual weld seam portions having a length of approximately 40 mm, spacings between adjacent weld seam portions being able to be approximately 20 mm.

The transition region between a sandwich panel 1 and a connecting profile 4 according to FIG. 3 corresponds to the greatest possible extent to what has been explained by way of FIG. 1. However, the sealing strips 9 between the adhesive surfaces 8 on the one hand and the end regions 10 on the other hand are replaced by so-called “resin traps” which are present in the form of grooves 12. Excessive adhesive, which arises when the protruding edge regions 6 of the cover layers 3 are bonded to the assigned outside surfaces of the edge portion 7 of the connecting profile 4, can be collected in said grooves 12, which can have a width of 5 mm, and consequently does not pass into the overlapping end regions 10 in which the weld seams 11 are to be provided.

The joining region between the sandwich panel 1 and the connecting profile 4, from the end face 6 of the foam core layer 2 up to the ends of the cover layers 3 in the direction of the connecting profile 4, is obviously realized in said region in a mirror-symmetrical manner with reference to a middle longitudinal plane.

1-11. (canceled)

12. A wall configuration for a vehicle, the wall configuration comprising:
a sandwich panel having two sides, said sandwich panel including a core layer having two sides and an end face and two metal cover layers each being disposed on a respective one of said sides of said core layer, each of said cover layers having a respective edge portion protruding beyond said end face of said core layer on at least one of said sides of said sandwich panel, said protruding edge portions of said cover layers having inner surfaces;
a metal connecting profile having an edge portion inserted into an intermediate space between said protruding edge portions of said cover layers, said edge portion of said connecting profile having outer surfaces;
adhesive layers each structurally connecting said inner surface of said protruding edge portion of one of said cover layers to a respective abutting one of said outer surfaces of said inserted edge portions of said connecting profile; and
a weld seam electrically conductively connecting at least one of said protruding edge portions of said cover layers to said abutting edge portion of said connecting profile at a spacing from one of said adhesive layers.

13. The wall configuration according to claim 1, wherein said adhesive layer faces said sandwich panel and said weld seam faces said connecting profile on at least one of said protruding edge portions.

14. The wall configuration according to claim 1, which further comprises a sealing layer disposed between said adhesive layer and said weld seam on at least one of said protruding edge portions.

15. The wall configuration according to claim 1, which further comprises a groove for receiving excessive adhesive, said groove being disposed between said adhesive layer and said weld seam on at least one of said protruding edge portions.

16. The wall configuration according to claim 1, wherein said adhesive layer has a width of between 20 and 50 mm on at least one of said protruding edge portions.

17. The wall configuration according to claim 1, wherein said weld seam is situated at a spacing of at least 5 mm from said adhesive layer on at least one of said protruding edge portions.

18. The wall configuration according to claim 1, wherein said weld seam is constructed as a step seam on at least one of said protruding edge portions.

19. The wall configuration according to claim 1, wherein at least one of said protruding edge portions includes an adhesive layer free end region having a width of at least 10 mm.

20. The wall configuration according to claim 1, wherein said sandwich panel forms a roof wall.

21. The wall configuration according to claim 1, wherein said weld seam is a laser weld seam.

22. The wall configuration according to claim 1, wherein said sandwich panel has a middle longitudinal plane, and said sandwich panel and said connecting profile define a joining region therebetween being mirror-symmetrical relative to said middle longitudinal plane in a vicinity of said two protruding edge portions of said cover layers.
